(19) United States
(12) Patent Application Publication
(10) Pub. No.: US 2026/0159032 A1
(43) Pub. Date: Jun. 11, 2026

(54) SYSTEM AND METHOD TO LOCATE A VEHICLE ACCESS DEVICE

(71) Applicant: FCA US LLC, Auburn Hills, MI (US)

(72) Inventors: Ahmad Saleh, Auburn Hills, MI (US); Jaycil Z. Varghese, Auburn Hills, MI (US)

(21) Appl. No.: 18/976,890

(22) Filed: Dec. 11, 2024

(51) Int. Cl. B60R 25/24; B60R 25/10; B60R 25/104; G07C 9/00; H04B 17/318

(52) U.S. Cl. CPC B60R 25/245; B60R 25/104; G07C 9/00309; H04B 17/318; B60R 2025/1013; G07C 2009/00793; G07C 2209/63

(57) ABSTRACT

A method for locating a vehicle access device may include the steps of detecting a signal from a vehicle access device, determining a location of the vehicle access device relative to one or more vehicle access devices, and communicating the location of the vehicle access device. The location of the vehicle access device can be determined to be either within or outside of the vehicle by determining the strength of communication or signal received from the vehicle access device. With one or more access device sensors, the approximate location within or outside of the vehicle relative to the location of the one or more access device sensors can be determined and communicated to a user of the vehicle.

### FIELD

The present disclosure relates to a vehicle access device and a system and method for locating the vehicle access device.

### BACKGROUND

Vehicles may use key fobs to operate one or more vehicle functions such as unlocking or locking doors, opening, or closing doors, or starting a vehicle's ignition. However, key fobs are generally small for portability and may be misplaced by a user of the vehicle. When a key fob is lost, the user must attempt to remember where it was placed, often requiring a search of the vehicle interior, the environment near the vehicle, and/or other locations the user has traveled to with the key fob.

### SUMMARY

In at least some implementations, a method for locating a vehicle access device includes detecting a signal from a vehicle access device with one or more access device sensors, determining a location of the vehicle access device relative to the one or more access device sensors, and communicating the location of the vehicle access device.

In at least some implementations, detecting a signal from a vehicle access device is accomplished by either the access device or the one or more access device sensors sending wireless communication and the other of the vehicle access device or the one or more access device sensors receiving wireless communication.

In at least some implementations, wireless communication is one or more of cellular, ultra-wideband (UWB), WiFi, satellite communications, radio, or Bluetooth.

In at least some implementations, the step of determining a location of the vehicle access device relative to one or more access device sensors includes determining the signal strength of a communication between the one or more access device sensors and the vehicle access device.

In at least some implementations, when the signal strength of the communication between the one or more access device sensors and the vehicle access device is greater than a predetermined threshold, the vehicle access device is determined to be located within the vehicle.

In at least some implementations, the step of communicating the location of the vehicle access device includes visually, audibly, or tactilely communicating the location of the vehicle access device through an external device or a user interface of a vehicle.

In at least some implementations, the method may include comparing the signal strength of the communication received at the one or more access device sensors to determine the approximate location of the vehicle access device relative to the one or more access device sensors.

In at least some implementations, the step of communicating the location of the vehicle access device includes visually, audibly, or tactilely communicating the location of the vehicle access device through an external device or a user interface of a vehicle.

In at least some implementations, when the signal strength of the communication between the one or more access device sensors is less than a predetermined threshold, the vehicle access device is determined to be located outside of the vehicle.

In at least some implementations, the step of communicating the location of the vehicle access device includes visually, audibly, or tactilely communicating the location of the vehicle access device through an external device or a user interface of a vehicle.

In at least some implementations, the method includes comparing the signal strength of communication or signal between each of the multiple access device sensors is compared to determine the approximate location of the vehicle access device relative to the vehicle.

In at least some implementations, the step of communicating the location of the vehicle access device includes visually, audibly, or tactilely communicating the location of the vehicle access device through an external device or a user interface of a vehicle.

In at least some implementations, the step of determining a location of the vehicle access device relative to the one or more access device sensors includes determining an elapsed time between sending a communication from either the access device sensor or the vehicle access device and receiving a communication from the other of the access device sensor or the vehicle access device.

In at least some implementations, when the elapsed time of the communication between the one or more access device sensors and the vehicle access device is greater than a predetermined threshold, the vehicle access device is determined to be located outside of the vehicle, or when the elapsed time of the communication between the one or more access device sensors and the vehicle access device is less than a predetermined threshold, the vehicle access device is determined to be located within the vehicle.

In at least some implementations, the method includes comparing the elapsed time of the communication received at the one or more access device sensors to determine the approximate location of the vehicle access device relative to the one or more access device sensors.

In at least some implementations, the step of communicating the location of the vehicle access device includes visually, audibly, or tactilely communicating the location of the vehicle access device through an external device or a user interface of a vehicle.

In at least some implementations, a method for locating a vehicle access device includes detecting a change of one or more conditions, detecting a communication from a vehicle access device, comparing a signal strength of the detected communication or an elapsed time of communication between the vehicle access device and an access device sensor to a predetermined threshold, and communicating that the vehicle access device has been left in a vehicle to an external device or a user interface of the vehicle when the signal strength is greater than the predetermined threshold.

In at least some implementations, the one or more conditions are door position of the vehicle, window position of the vehicle, drivetrain position of the vehicle, or ignition position of the vehicle.

In at least some implementations, based on the signal strength of the communication or the elapsed time of communication between the vehicle access device and an access device sensor, the approximate location of the vehicle access device within the vehicle is determined.

In at least some implementations, the step of communicating that the vehicle access device has been left in a vehicle to an external device or a user interface of the vehicle includes communicating the approximate location of the vehicle access device within the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic of a system to locate a vehicle access device;

FIG. 2 is another schematic of the system to locate the vehicle access device;

FIG. 3 is another schematic of the system to locate the vehicle access device;

FIG. 4 is another schematic of the system to locate the vehicle access device; and

FIG. 5 is a flowchart depicting a method for locating the vehicle access device.

### DETAILED DESCRIPTION

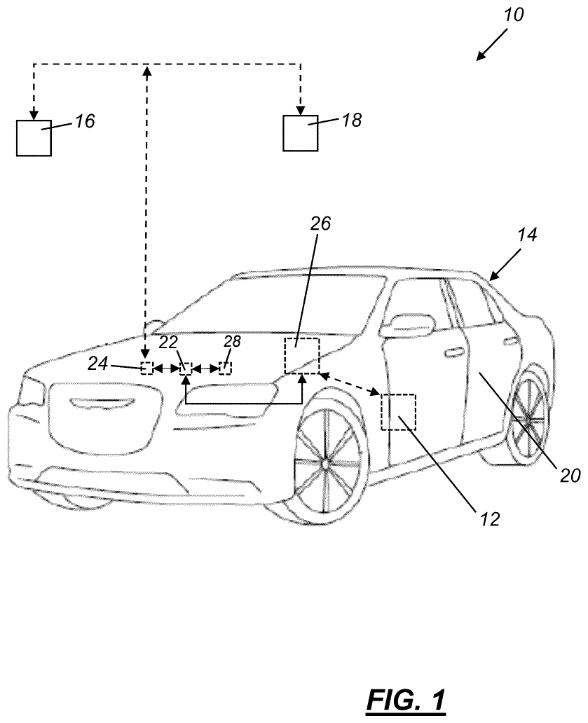

Referring in more detail to the drawings, FIGS. 1-4 show a system 10 for locating a vehicle access device 12. The vehicle access device 12 may be, by way of a non-limiting example, a so-called “key fob” or other wireless device by which, by way of non-limiting examples, door locks may be remotely operated, a vehicle ignition actuated or enabled, and other vehicle functions performed as commanded by a user. The system 10 may include a vehicle 14, the vehicle access device 12, an external device 16 by which a user can send and receive communications, and a network/remote server 18 by which the external device 16 can communicate with the vehicle 14.

The vehicle 14 may include a body 20 with body panels, doors, locks for the doors, a control system 22, a communications device 24 with a transmitter and a receiver, one or more access device sensors 26, and a user interface 28. The vehicle transmitter is capable of transmitting wireless communications and the vehicle receiver is capable of receiving wireless communications. For example, wireless communications may be cellular, ultra-wideband (UWB), WiFi, satellite communications, radio, Bluetooth, or others. The communications device 24 may be defined by separate components (e.g. for the transmitter and receiver) or integrated into a single component depending on the embodiment.

The vehicle control system 22 is in communication with the communications device 24 such that the control system 22 can transmit and receive signals and information via the communications device 24. The control system 22 has one or more controllers or processors, memory and instructions or programs stored in the memory or otherwise accessible by the processor(s). In some implementations, the control system 22 may have or be defined by a plurality of vehicle controllers, such as but not limited to, an infotainment module, a telematics module, body control module, powertrain control module, and the like, and the controllers may be independent or networked to each other. Each of the controllers may communicate with one or more vehicle components or system components. The communication device 24 is in communication with the control system 22, and is capable of receiving communication from the vehicle access device 12 and relaying that communication to the control system 22 to permit use of the vehicle access device 12 with the vehicle 14.

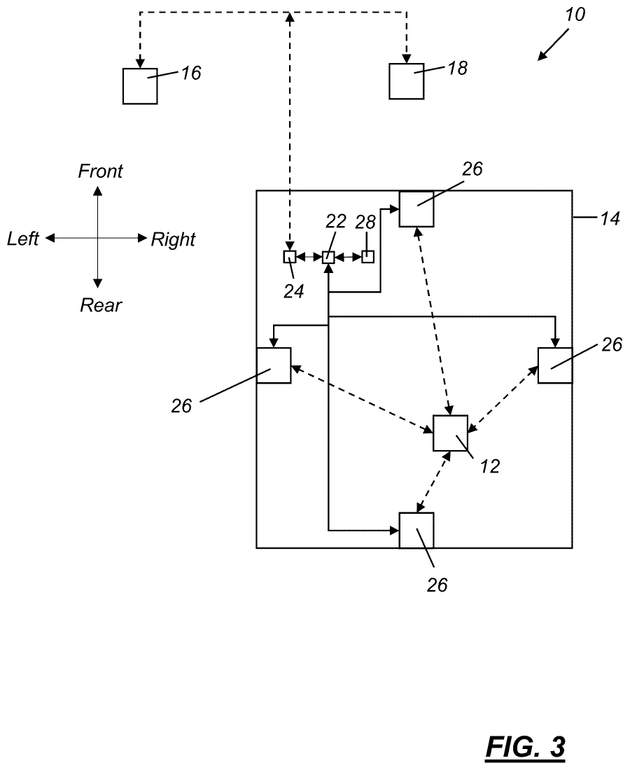

The one or more access device sensors 26 may be positioned on or within the vehicle 14 and each may have a receiver capable of receiving signals or communications transmitted from the vehicle access device 12 and determining the signal strength of the communication from the vehicle access device 12. Communication to and/or from the access device sensors 26 can be any form of wireless communication such as, but not limited to short-range or long-range communications, such as cellular, ultra-wideband (UWB), near-field communications, Bluetooth, WiFi, satellite communications, radio, or others. As shown in FIG. 3, four vehicle access sensors 26 are spaced apart from each other, and positioned at front, rear, left, and right positions of the vehicle 14. One or more of the access device sensors 26 may simultaneously receive communication from the vehicle access device 12.

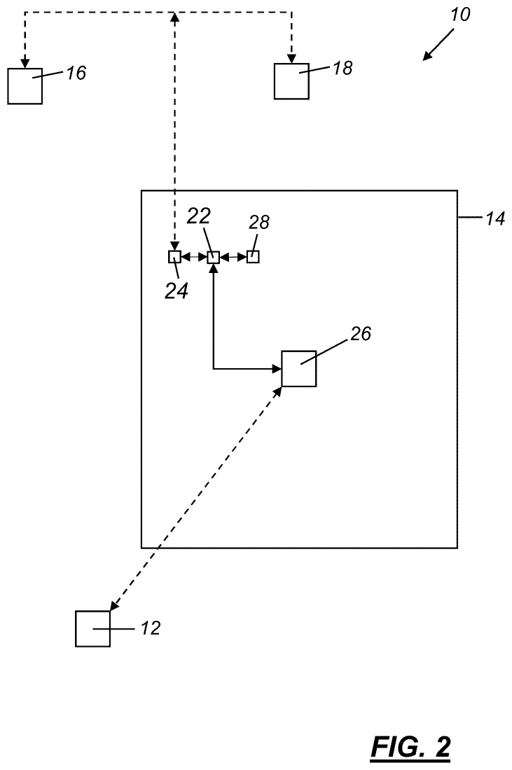

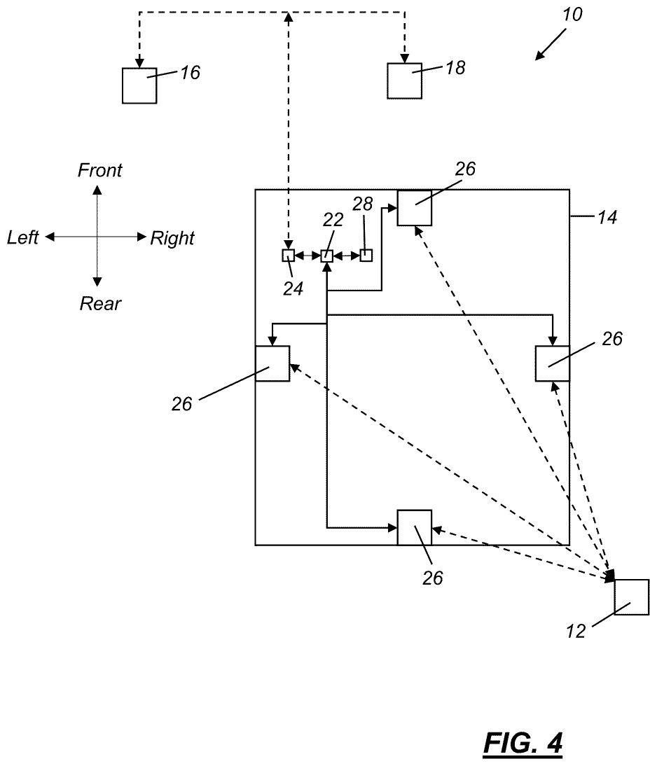

Based upon the signal strength of communication received at each of the one or more access device sensors 26 or the elapsed time between sending and receiving the signal or communication the approximate distance from the vehicle access device 12 relative to each of the one or more access device sensors 26 may be determined. Using known locations of the access device sensors 26 and the signal strength and/or the time between sending and receiving the signal at each access device sensor 26, the approximate location of the vehicle access device 12 can be determined. In FIGS. 1-2, a single access device sensor 26 is positioned centrally in the vehicle 14 although the access device sensor 26 may be located anywhere on or within the vehicle 14, as desired. In FIGS. 3-4, four access device sensors 26 are positioned at front, side, and rear positions of the vehicle 14. However, other quantities and positions of access device sensors 26 may be implemented as needed.

The user interface 28 may be part of a vehicle infotainment system, and may include a display visible by one or more vehicle occupants within the interior of the vehicle 14, a tactile feedback system capable of tactilely communicating information to a user, or a speaker capable of audibly communicating information to the user. The control system 22 may be in communication with the user interface 28 to provide various multimedia content and information to vehicle occupants, and to provide the user interface by which a user can enter information via the display or related inputs. In at least some implementations, user input via the user interface 28 may be provided through a touch-sensitive display, allowing vehicle occupant(s) to navigate through menus, adjust vehicle settings, and control features by tapping or swiping on the touchscreen. Some implementations may utilize physical controls to recognize vehicle occupant input such as button, knobs, or dials positioned within the interior of the vehicle 14. Other implementations may use voice recognition through integrated voice control systems allowing vehicle occupant(s) to operate vehicle functions using voice commands.

The vehicle access device 12 (e.g. key fob or external device such as a mobile phone) may have a body in which is housed a controller, a transmitter and one or more inputs via which the user can input commands to be sent to the communications device 24 and recognized by the vehicle control system 22. The input(s) may be provided on the body in the form of buttons, switches, capacitive touch, a touch screen, voice recognition, motion sensors, or other user interface, as desired.

The vehicle access device controller and transmitter are powered by a battery and capable of sending signals to the vehicle control system 22 in response to actuation of one or more of the user inputs. Communication from the vehicle access device transmitter can be any form of wireless communication such as, but not limited to short-range or long-range communications, such as cellular, ultra-wideband (UWB), near-field communications, Bluetooth, WiFi, satellite communications, radio, or others. When an input of the vehicle access device 12 is actuated by a user, the access device transmitter sends an output to and recognizable by the vehicle control system 22. For example, actuation of a first input of the vehicle access device 12 may send an output to the control system 22 to unlock one or more vehicle doors, actuation of a second input may cause a vehicle engine to start, actuation of a third input may cause a vehicle trunk or liftgate to open, and the like. In some implementations the vehicle access device 12 may have a speaker, a vibrating motor, or a display to provide audio, tactile, or visual feedback to the user.

The external device 16 may be owned or controlled by the vehicle owner or an authorized user of the vehicle 14 and may be a computer, smartphone, tablet, or other electronic device permitting communication to and from the user. The external device 16 has one or more processors, memory, and instructions or programs stored in the memory or otherwise accessible by the processors. The external device 16 has a communication unit with a device transmitter capable of transmitting signals wirelessly, and a device receiver capable of receiving signals wirelessly. Communication to and from the external device 16 can be any form of wireless communication such as, but not limited to cellular, ultra-wideband (UWB), WiFi, satellite communications, radio, or others. The external device 16 may have GPS capability to determine the real-time location of the external device 16. Previous locations of the external device 16 may be saved in the memory of the external device 16 and displayed to a user on a screen or communicated to the vehicle 14 or the remote server 18.

The external device 16 may include a screen capable of displaying information to a user, a tactile feedback system capable of tactilely communicating information to a user, or a speaker capable of audibly communicating information to the user. The one or more processors are in communication with the screen and the external device 16 may include an input system capable of obtaining user input and communicating the user input to the one or more processors. In some implementations, the external device 16 may perform one or more functions of the vehicle access device 12 to control aspects of the vehicle 14. The external device 16 may communicate directly with the communications device 24 of the vehicle, or the remote server 18 to control the vehicle 14.

In at least some embodiments, the vehicle control system 22 and/or the external device 16 may communicate with the remote server 18, which may be part of a backend portion of a cloud-based system, and may include one or more processors, memory/data storage and programs to implement the functions required of the remote server 18. The remote server 18 may facilitate communication between the vehicle communications device 24 and the external device 16. The remote server 18 may be capable of receiving and transmitting communications through wireless communication such as, but not limited to, cellular, ultra-wideband (UWB), WiFi, satellite communications, radio, or others. Upon receiving communication from either the external device 16 or the vehicle 14, the remote server 18 may handle the request which may include querying local or remote memory, performing computations, or executing computer code. After handling the request, the remote server 18 formats and sends communications to the intended destination, which may include either the external device 16 or the vehicle control system 22. The intended destination may receive the communication and, in some implementations, send an acknowledgement of receipt back to the remote server 18.

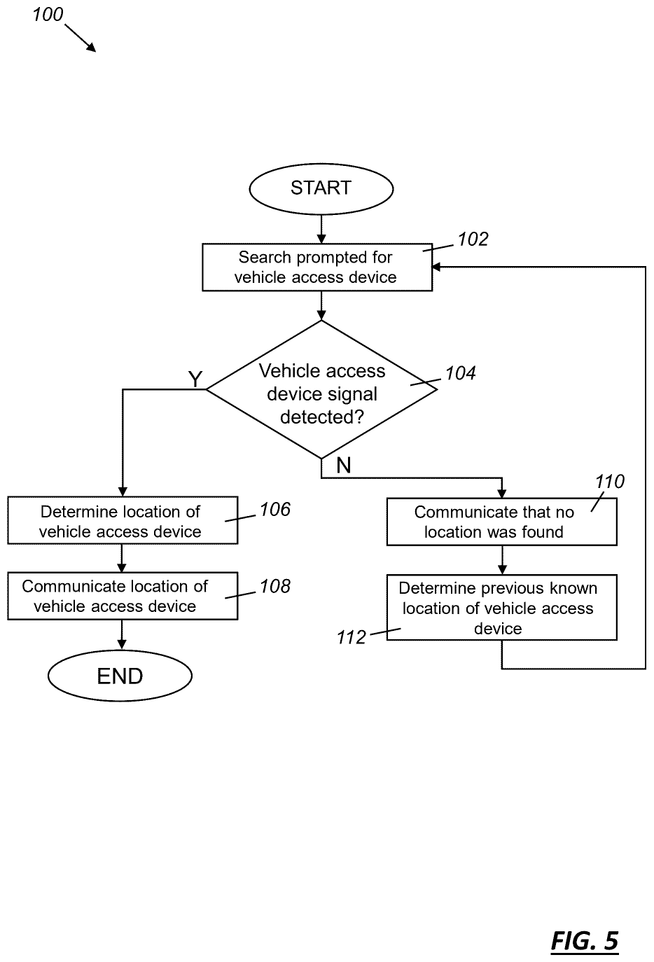

A method 100 for locating a vehicle access device 12 is shown in FIG. 5. In step 102, a user or the control system 22 of the vehicle 14 may prompt the vehicle 14 to search for a lost or misplaced vehicle access device 12. The user may use the user interface 28 (e.g. infotainment system in the vehicle) or the external device 16 to request a search be conducted, or alternatively, the control system 22 of the vehicle 14 may prompt a search for the vehicle access device 12 when certain conditions are met. For example, the control system 22 may cause a search to start when a vehicle driver door (e.g. a door closest to a driver or operator seat of the vehicle) is opened and then shut while the ignition or power of the vehicle is switched off, indicating that the driver/operator has left the vehicle 14. Other conditions such as the position of one or more windows of the vehicle 14, feedback from a driver seat occupancy sensor, the position of the vehicle's drivetrain (park, drive, reverse, etc.), or the GPS location of the vehicle 14 may prompt a search for the vehicle access device 12.

In step 104, the one or more access device sensors 26 of the vehicle 14 attempt to receive communication from the vehicle access device 12 to determine whether the vehicle access device 12 is near the vehicle 14 (i.e. within range of the one or more access device sensors 26). The one or more access device sensors 26 may await communication from the vehicle access device 12, which may periodically ping or send out a transmission seeking to pair or connect with the vehicle 14. Or the vehicle/access device sensors 14, 26 may send a signal/communication to be received by the vehicle access device 12. Upon receiving communication from the one or more access device sensors 26, the vehicle access device 12 may confirm receipt by sending communication back to the one or more access device sensors 26. If communication between the one or more access device sensors 26 and the vehicle access device 12 is possible, indicating that the vehicle access device 12 is near the vehicle 14, the method 100 advances to step 106. If communication between the one or more access device sensors 26 and the vehicle access device 12 is not possible the method 100 advances to step 110.

In step 106, the approximate location of the vehicle access device 12 relative to the vehicle 14 (e.g. the access device sensors of the vehicle) is determined. In FIGS. 1-2, the vehicle 14 has a single access device sensor 26. As shown by FIG. 1, the vehicle access device 12 is within the vehicle 14 and in range of the access device sensor 26 and may communicate with the access device sensor 26. FIG. 2 shows the vehicle access device 12 within range of the access device sensor 26, but outside of the vehicle 14. The control system 22 may estimate the distance the vehicle access device 12 is from the access device sensor 26 based on the strength of the communication (signal) from the vehicle access device 12 to the access device sensor 26 and based on the position of the access device sensor 26 relative to the vehicle 14. The distance from the vehicle access device 12 to the access device sensor 26 represents a radius from the access device sensor 26 that the vehicle access device 12 is located within. Therefore, the control system 22 may differentiate between the scenarios shown in FIGS. 1-2, where the vehicle access device 12 may be within the vehicle 14 (FIG. 1) or outside of the vehicle 14 (FIG. 2).

The distance from the vehicle access device 12 to the access device sensor 26 may also be determined based on the elapsed time between sending and receiving communication between the vehicle access device 12 and the access device sensor 26. When the speed the communication travels is known, which in some implementations may be the speed of light (approximately 3*108 m/s), the time between sending and receiving communication may be multiplied by the speed of the communication to determine the distance from the vehicle access device 12 to the access device sensor 26. For example, the vehicle 14 may send a first signal at a time of T₀. The vehicle access device 12 may receive the first signal at a time of T₁. By subtracting T₁ by T₀ and multiplying by the speed of travel of the signal, the distance, in units of the speed of travel may be obtained. As another example, the vehicle access device 12 may send a second signal at T₂. The vehicle 14 may receive the second signal from the vehicle access device 12 at T₃. The time elapsed between T₃ and T₀ is the time of travel of the first signal and the second signal plus any processing time of the vehicle access device 12 in receiving the first signal and sending the second signal. The time elapsed between T₂ and T₁ is the processing time of the vehicle access device 12 between receiving the first signal and sending the second signal. The distance between the vehicle access device 12 and the access device sensor 26 of the vehicle 14 may be determined by subtracting the time of travel of the signal plus any processing time of the vehicle access device 12 in receiving the first signal and sending the second signal by the processing time of the vehicle access device 12 in receiving the first signal and sending the second signal, multiplying by the speed of travel of the signal, and dividing by two to account for the first signal and second signal each traveling the distance to and from the vehicle access device 12. The distance may be represented by the following formula:

$${D}_{1} = \frac{{T}_{3} - {T}_{0} - ( {T}_{2} - {T}_{1} )}{2} * ( speed of travel of signal )$$

When the distance calculated from the elapsed time is less than a predetermined threshold, the vehicle access device may be determined to be within the vehicle (as shown by FIG. 1). When the distance calculated from the elapsed time is greater than a predetermined threshold, the vehicle access device may be determined to be outside of the vehicle (as shown by FIG. 2).

To further confirm the distance between the vehicle access device 12 and the access device sensor 26, the vehicle 14 may send a third signal to the vehicle access device 12 at time T₄. The vehicle access device 12 may receive the third signal at time T₅. The time elapsed between T₅ and T₂ is the time of travel of the second signal and the third signal plus any processing time of the vehicle 14 in receiving the second signal and sending the third signal. The time elapsed between T₄ and T₃ is the processing time of the vehicle 14 in receiving the second signal and sending the third signal. The distance between the vehicle access device 12 and the access device sensor 26 of the vehicle 14 may be determined by subtracting the time of travel of the signal plus any processing time of the vehicle in receiving the second signal and sending the third signal by the processing time of the vehicle 14 in receiving the second signal and sending the third signal, multiplying by the speed of travel of the signal, and dividing by two to account for the second signal and third signal each traveling the distance to and from the vehicle access device 12. The distance may be represented by the following formula:

$${D}_{2} = \frac{{T}_{5} - {T}_{2} - ( {T}_{4} - {T}_{3} )}{2} * ( speed of travel of signal )$$

In the example shown in FIGS. 3-4, the vehicle 14 has four access device sensors 26 positioned at known locations of the vehicle 14. The strength of a signal or the time between sending and receiving the signal or communication the approximate distance from the vehicle access device 12 received at each sensor 26 after a communication from the access device 12 is a function of the distance of the vehicle access device 12 from each sensor 26. Generally, the greater the signal strength, or the greater the time elapsed between sending and receiving the communication/signal, the closer the vehicle access device 12 is to the access device sensor 26. Therefore, in implementations having multiple access device sensors 26, by comparing the signal strengths at each access device sensor 26, or elapsed time between sending and receiving the commination/signal at the access device sensors 26 and the vehicle access device 12, the approximate distance from each access device sensor can be determined using, for example, a predetermined relationship between signal strength and distance, or by multiplying the elapsed time between sending and receiving the communication/signal by the speed of travel of the communication/signal as previously described. Based on the estimated distance the vehicle access device 12 is from each access device sensor 26, the control system 22 may differentiate between when the vehicle access device 12 is within the vehicle 14 (FIG. 3) and outside of the vehicle 14 (FIG. 4).

The approximate location of the vehicle access device 12 may be further narrowed to be in a specific portion of the vehicle 14 if the vehicle access device 12 is determined to be within the vehicle 14 or a specific direction from the vehicle 14 if the vehicle access device 12 is determined to be outside of the vehicle 14. For example, in FIGS. 1-2, the approximate distance between the vehicle access device 14 to the single access device sensor 26 is known. Therefore, the vehicle access device 26 is located somewhere at the known distance within an area circumferentially surrounding the access device sensor 26. Another example, as shown in FIG. 3, if all access device sensors 26 detect the vehicle access device 12 within a predetermined distance, indicating the vehicle access device 12 is within the vehicle 14, and the strongest signal is received by the rear and right access device sensors the control system 22 determines that the vehicle access device 26 is in a rear-right position within the vehicle 14.

In yet another example, as shown in FIG. 4, if the received signal strength is greater at the access device sensor 26 positioned at the rear of the vehicle 14 and the access device sensor positioned at the right of the vehicle 14 and the differential between the signal strength of the strongest signal received by one of the access device sensors 26 and the weakest signal received by one of the access device sensors 26 is beyond a predetermined threshold, the vehicle access device is determined to be outside of the vehicle 14 and generally in a rear-right direction. In this example, any differential between the access device sensor 26 positioned at the rear of the vehicle 14 and the access device sensor 26 positioned at the right of the vehicle 14 can determine whether the vehicle access device 12 is closer to the vehicle 14 in either the rear or right directions. Logic, like that applied in the previous examples, may be implemented by the control system 22 to determine any location of the vehicle access device 12 when the vehicle access device 12 is within a range of the one or more access device sensors 26.

Furthermore, as shown in FIG. 4, the elapsed time of sending and receiving communication between the access device sensors 26 and the vehicle access device 12 may be used to determine the specific location of the vehicle access device 12 relative to the vehicle 14. For example, after the distance of the vehicle access device 12 from each access device sensor 26 is determined, the distances can be compared to determine the location of the vehicle access device. In FIG. 4, the rear and right access device sensors 26 would have shorter elapsed time of communication compared to the front and left access device sensors 26. This indicates that the vehicle access device 12 is closer to the rear and right access device sensors, and therefore, positioned rear and right from the vehicle 14.

In some implementations, when the vehicle access device 12 is within the vehicle 14 and one or more conditions, such as those described earlier, indicate that the vehicle access device 12 may be unintentionally left behind in the vehicle 14, the control system 22 may alert the user via the user interface 28, the external device 16, or the vehicle access device 12 if the vehicle access device 12 is equipped to do so. This may proactively seek to prevent a user from unintentionally leaving a vehicle access device 12 in the vehicle 14.

In step 108, after the approximate location of the vehicle access device 12 has been determined, the approximate location is communicated to a user. The control system 22 may display information about the location of the vehicle access device 12 on the user interface 28, via a display or other vehicle system, to the user. Alternatively, the control system 22 may send the location through the communications device 22 directly to the external device 16 via wireless communication, or indirectly to the external device 16 via the remote server 18 to inform the user of the location of the vehicle access device 12. Upon successfully locating the vehicle access device 12, which may be determined by bringing the vehicle access device 12 within a certain distance of the vehicle 14, activating a button or function of the vehicle access device 12, or by receiving confirmation from the user that the vehicle access device 12 has been successfully located (through the external device 16, user interface 28, or by other means), or by other interaction(s) between the vehicle access device 12 and the vehicle 14, the method 100 ends.

If, in step 104, the one or more access device sensors 26 are unable to receive a signal from the vehicle access device 12, then the method 100 continues from step 104 to step 110. In step 110, it is communicated to the user that the vehicle access device 12 was not located by the search. This may involve communication between the external device 16, the remote server 18, the vehicle communications device 24, and/or the user interface 28 as previously described in steps 106-108. After communicating to the user that the vehicle access device 12 was not located, the method 100 continues to step 112.

In step 112, a previous known location of the vehicle access device 12 is determined. The times and locations at which the vehicle access device 12 is detected by the one or more access device sensors 26, or the times and locations where/when the access device 12 was used to control one or more vehicle functions, may be periodically or continuously logged by the memory of the control system 22. The location may be or include GPS coordinates of the vehicle's location at the time the vehicle access device 12 is detected. A previous time and/or location, possibly the most recent time and the location associated with that time, may be communicated to the user through the user interface 28 or the external device 16 by way of direct communication, from the control system 22 to the communications device 24 to the external device 16, or indirect communication, from the control system 22 to the communications device 24 to the remote server 18 to the external device 16. Upon receiving the previous time and/or location that the vehicle access device 12 was near the vehicle 14, the user may travel with the vehicle 14 to that location to find the vehicle access device 12 (e.g. using a second vehicle access device to operate the vehicle 14, which may be the external device 16 or a separate device from the external device 16, such as a second key fob). Upon reaching the location that the vehicle access device 12 was known to previously be near the vehicle 14, the method 100 may restart at step 102.

What is claimed is:

1. A method for locating a vehicle access device, the method comprising the steps of:
detecting a signal from a vehicle access device with one or more access device sensors;
determining a location of the vehicle access device relative to the one or more access device sensors; and
communicating the location of the vehicle access device.

2. The method of claim 1, wherein detecting a signal from a vehicle access device is accomplished by either the access device or the one or more access device sensors sending wireless communication and the other of the vehicle access device or the one or more access device sensors receiving wireless communication.

3. The method of claim 2, wherein wireless communication is one or more of cellular, ultra-wideband (UWB), WiFi, satellite communications, radio, or Bluetooth.

4. The method of claim 1, wherein the step of determining a location of the vehicle access device relative to one or more access device sensors includes determining the signal strength of a communication between the one or more access device sensors and the vehicle access device.

5. The method of claim 4, wherein when the signal strength of the communication between the one or more access device sensors and the vehicle access device is greater than a predetermined threshold, the vehicle access device is determined to be located within the vehicle.

6. The method of claim 5, wherein the step of communicating the location of the vehicle access device includes visually, audibly, or tactilely communicating the location of the vehicle access device through an external device or a user interface of a vehicle.

7. The method of claim 5, which also includes comparing the signal strength of the communication received at the one or more access device sensors to determine the approximate location of the vehicle access device relative to the one or more access device sensors.

8. The method of claim 7, wherein the step of communicating the location of the vehicle access device includes visually, audibly, or tactilely communicating the location of the vehicle access device through an external device or a user interface of a vehicle.

9. The method of claim 4, wherein when the signal strength of the communication between the one or more access device sensors is less than a predetermined threshold, the vehicle access device is determined to be located outside of the vehicle.

10. The method of claim 9, wherein the step of communicating the location of the vehicle access device includes visually, audibly, or tactilely communicating the location of the vehicle access device through an external device or a user interface of a vehicle.

11. The method of claim 9, which also includes comparing the signal strength of communication or signal between each of the multiple access device sensors is compared to determine the approximate location of the vehicle access device relative to the vehicle.

12. The method of claim 11, wherein the step of communicating the location of the vehicle access device includes visually, audibly, or tactilely communicating the location of the vehicle access device through an external device or a user interface of a vehicle.

13. The method of claim 1, wherein the step of determining a location of the vehicle access device relative to the one or more access device sensors includes determining an elapsed time between sending a communication from either the access device sensor or the vehicle access device and receiving a communication from the other of the access device sensor or the vehicle access device.

14. The method of claim 13, wherein when the elapsed time of the communication between the one or more access device sensors and the vehicle access device is greater than a predetermined threshold, the vehicle access device is determined to be located outside of the vehicle, or when the elapsed time of the communication between the one or more access device sensors and the vehicle access device is less than a predetermined threshold, the vehicle access device is determined to be located within the vehicle.

15. The method of claim 13, which also includes comparing the elapsed time of the communication received at the one or more access device sensors to determine the approximate location of the vehicle access device relative to the one or more access device sensors.

16. The method of claim 13, wherein the step of communicating the location of the vehicle access device includes visually, audibly, or tactilely communicating the location of the vehicle access device through an external device or a user interface of a vehicle.

17. A method for locating a vehicle access device, the method comprising the steps of:
detecting a change of one or more conditions;
detecting a communication from a vehicle access device,
comparing a signal strength of the detected communication or an elapsed time of communication between the vehicle access device and an access device sensor to a predetermined threshold; and
communicating that the vehicle access device has been left in a vehicle to an external device or a user interface of the vehicle when the signal strength is greater than the predetermined threshold.

18. The method of claim 17, wherein the one or more conditions are door position of the vehicle, window position of the vehicle, drivetrain position of the vehicle, or ignition position of the vehicle.

19. The method of claim 17, wherein based on the signal strength of the communication or the elapsed time of communication between the vehicle access device and an access device sensor, the approximate location of the vehicle access device within the vehicle is determined.

20. The method of claim 19, wherein the step of communicating that the vehicle access device has been left in a vehicle to an external device or a user interface of the vehicle includes communicating the approximate location of the vehicle access device within the vehicle.
